(19) United States
(12) Patent Application Publication
(10) Pub. No.: US 2015/0212693 A1
(43) Pub. Date: Jul. 30, 2015

(54) INTERACTION METHOD AND APPARATUS FOR LISTING DATA ON MOBILE TERMINAL

(71) Applicant: TENCENT TECHNOLOGY (SHENZHEN) COMPANY LIMITED, Shenzhen (CN)

(72) Inventor: YIMING QI, Shenzhen (CN)

(73) Assignee: TENCENT TECHNOLOGY (SHENZHEN) COMPANY LIMITED

(21) Appl. No.: 14/678,416

(22) Filed: Apr. 3, 2015

Related U.S. Application Data
(63) Continuation of application No. PCT/CN2013/079307, filed on Jul. 12, 2013.

(30) Foreign Application Priority Data
Oct. 9, 2012 (CN) 2012-10379623.5

(51) Int. Cl. G06F 3/0481; G06F 3/0484; G06F 3/0488; G06F 3/0482

(52) U.S. Cl. CPC G06F 3/04817; G06F 3/0482; G06F 3/04842; G06F 3/0488

(57) ABSTRACT

The present disclosure relates to an interaction method for list data in a mobile terminal, where the method includes: selecting a data list that needs to be operated on; switching the data list to grid-form icons, so as to increase the number of displayable data entries; and performing a corresponding data operation according to a set operation manner for the grid-form icons. The present disclosure further provides an interaction apparatus for list data in a mobile terminal. The interaction method and apparatus for list data in a mobile terminal in embodiments of the present disclosure greatly increase, by using format switching, the number of displayed data entries between ListView and Gridview, so as to manage more data lists; and perform an operation on data by using a gesture and a pop-up menu, and perform an operation on a single piece of data or batch data in a visual and convenient manner, thereby preventing inconvenience caused by frequent slides on a screen or/and long-pressing a scroll bar, and improving operation efficiency.

### RELATED APPLICATION

This application is a continuation of PCT Application No. PCT/CN 2013/079307, filed on Jul. 12, 2013, which claims priority to Chinese Patent Application No. 201210379623.5, entitled “INTERACTION METHOD AND APPARATUS FOR LIST DATA ON MOBILE TERMINAL” filed on Oct. 9, 2012, which is incorporated by reference in its entirety.

### FIELD OF THE TECHNOLOGY

The present disclosure relates to the field of Internet technologies, and in particular, relates to an interaction method and apparatus for listing data on a mobile terminal.

BACKGROUND OF THE DISCLOSURE

A list is a most common form of presenting multiple pieces of data. However, due to a limitation of the size of a screen of a mobile terminal, the amount of data displayed at one time is limited. When a user needs to perform an operation on a single piece of data or batch data and the data to be operated on has a large span, the user needs to frequently slide the screen or/and long-press a scroll bar to select a data entry. This operation manner may easily cause data misoperation and may be inconvenient to select data in batches, and operation efficiency is low.

### SUMMARY

The present disclosure provides an interaction method and apparatus for listing data on a mobile terminal, and aims to solve technical problems in existing technologies that a list data operation manner easily causes a data misoperation with inconvenience of selecting data.

An objective of the present disclosure and a technical problem to be solved of the present disclosure are implemented by using the following technical solutions.

The present disclosure provides an interaction method for listing data on a mobile terminal, including: selecting a data list that needs to be operated on; switching the data list to grid-form icons, so as to increase the number of displayable data entries; and performing a corresponding data operation according to a set operation manner for the grid-form icons.

The present disclosure further provides an interaction apparatus for listing data on a mobile terminal, including: a list selection module, configured to select a data list that needs to be operated on; a format switching module, configured to switch the data list to grid-form icons, so as to increase the number of displayable data entries; and an operation performing module, configured to perform a corresponding data operation according to a set operation manner for the grid-form icons.

The technical solutions in the embodiments of the present disclosure have the following advantages and beneficial effects. The interaction method and apparatus for listing data on a mobile terminal in the embodiments of the present disclosure greatly increase, by using format switching, e.g., between ListView and Gridview, the number of data entries displayed at one time, so as to manage more data lists; and perform an operation on data by using a gesture and a pop-up menu, and perform an operation on a single piece of data or batch data in a visual and convenient manner, thereby preventing inconvenience caused by frequent slides on a screen or/and a long press on a scroll bar, and improving operation efficiency. In addition, a data operation gesture in the present disclosure may be set according to different user preferences, so as to meet a personalization requirement of a user.

The above description is only a summary of the technical solutions of the present disclosure. To make the technical means of the present disclosure better understood for implementation according to the content of the specification and to make the above and other objectives, features, and advantages of the present disclosure easily understood, preferred embodiments will be described below in detail with reference to the accompanying drawings. Other aspects or embodiments of the present disclosure can be understood by those skilled in the art in light of the description, the claims, and the drawings of the present disclosure.

### BRIEF DESCRIPTION OF THE DRAWINGS

FIG. 1 is a flowchart of an interaction method for listing data on a mobile terminal according to a first exemplary embodiment of the present disclosure;

FIG. 2 is a schematic diagram of an operation of switching a data list to grid-form icons according to various embodiments of the present disclosure;

FIG. 3 is a flowchart of an interaction method for listing data on a mobile terminal according to a second exemplary embodiment of the present disclosure;

FIG. 4 is a schematic diagram of an operation on a single piece of data on grid-form icons according to various embodiments of the present disclosure;

FIG. 5 is a schematic diagram of an operation on batch data on grid-form icons according to various embodiments of the present disclosure;

FIG. 6 is a schematic diagram of a data movement operation on grid-form icons according to various embodiments of the present disclosure;

FIG. 7 is a schematic diagram of an area merging and grouping operation on the data on grid-form icons according to various embodiments of the present disclosure;

FIG. 8 is a schematic structural diagram of an interaction apparatus for listing data on a mobile terminal according to a first exemplary embodiment of the present disclosure;

FIG. 9 is a schematic structural diagram of an interaction apparatus for listing data on a mobile terminal according to a second exemplary embodiment of the present disclosure; and

FIG. 10 is a structural diagram of an exemplary mobile terminal 1000 consistent with various disclosed embodiments.

### DESCRIPTION OF EMBODIMENTS

To further explain the technical means used in the present disclosure for achieving the intended objectives and the effects thereof, specific implementation manners, methods, steps, structures, features, and effects of an interaction method and apparatus for listing data on a mobile terminal that are applied to a terminal and put forward by the present disclosure are described in detail below with reference to the accompanying drawings and preferred embodiments.

The foregoing and other technical content, characteristics, and effects of the present disclosure may be clearly displayed in the following detailed description of preferred embodiments with reference to the accompanying drawings. Through description of the specific implementation manners, the technical means used in the present disclosure for achieving the intended objectives and the effects thereof may be understood more deeply and specifically, but the accompanying drawings are used to provide reference and description, and is not used to limit the present disclosure.

Examples of mobile terminals that can be used in the embodiments include, but are not limited to, a tablet computer (which includes, but is not limited to, an Apple iPad, any touchscreen device that runs Apple iOS or Microsoft Surface, any touchscreen device that runs a Windows (Microsoft) operating system, and a tablet device that runs an Android operating system), a mobile phone, a smartphone (which includes, but is not limited to, an Apple iPhone, a Windows Phone, another smartphone that runs Windows Mobile (Microsoft Mobile) or Pocket PC (palmtop computer) operating system, and a smartphone that runs an Android operating system, a Blackberry operating system, and a Symbian operating system), an e-reader (which includes, but is not limited to, Amazon Kindle and Barnes & Noble Nook), a laptop computer (which includes, but is not limited to, a computer that runs an Apple Mac operating system, a Windows operating system, an Android operating system and/or a Google Chrome operating system), or an on-board device that runs any of the foregoing operating systems or any other operating system. All these are well known by a person skilled in the art.

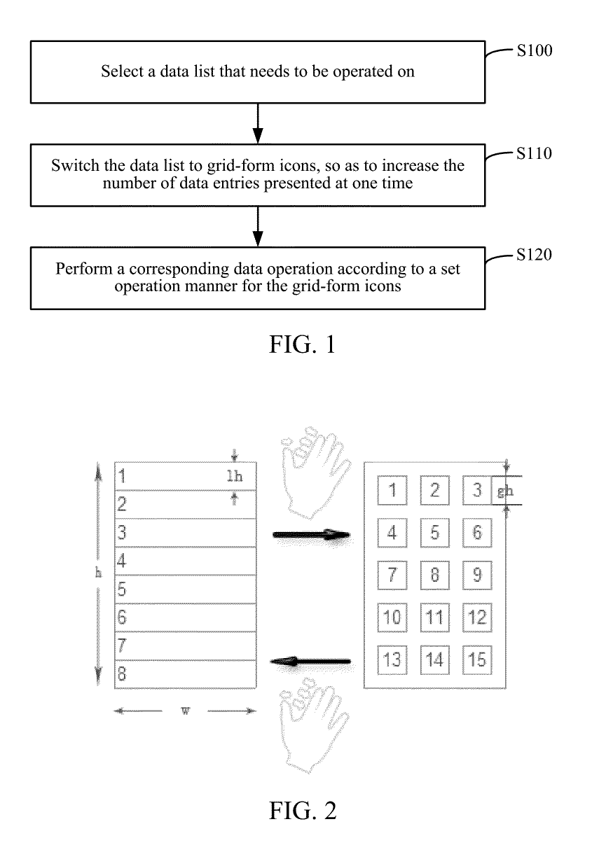

Referring to FIG. 1, FIG. 1 is a flowchart of an interaction method for listing data on a mobile terminal according to a first exemplary embodiment of the present disclosure.

The interaction method for listing data on the mobile terminal in the first exemplary embodiment of the present disclosure includes the following steps: Step 100 to select a data list that needs to be operated on, and Step 110 to switch the data list to grid-form icons, so as to increase the number of data entries displayable at one time.

In Step 110, a manner of switching the data list may be set according to user preferences. In this embodiment of the present disclosure, the manner of switching the data list is, for example, multi-finger touch and pinch. The number of data entries displayed at one time depends on the size of a cell of the grid-form icons. When a cell is bigger, less data is displayed at one time. When a cell is smaller, more data is displayed at one time. A user may set the size of a cell according to entries in a data list. In this embodiment of the present disclosure, after switching to grid-form icons, the number of displayed data entries increases from

$$\frac{h}{Lh}$$

displayed in an original list format to

$$\frac{h \times w}{{gh}^{2}} ,$$

where h is the height of the list, Lh is the height of a line, w is the width of the list, and gh is the height of a cell.

Specifically, referring to FIG. 2, FIG. 2 is a schematic diagram of an operation of switching a data list to grid-form icons in the present disclosure. The present disclosure greatly increases, by using format switching, e.g., between ListView (which may display items in four different views, and by using this control, items may be formed into a column with or without a column header, and an accompanying icon and text may be displayed) and Gridview (which is a composite control, and presents, in a tabular form, multiple columns of data), the number of data entries displayed at one time, so as to manage more data lists, and perform an operation on a single piece of data or batch data in a visual and convenient manner, thereby preventing inconvenience caused by frequent slides on a screen or/and a long press on a scroll bar.

Step 120 includes performing a corresponding data operation according to a set operation manner for the grid-form icons.

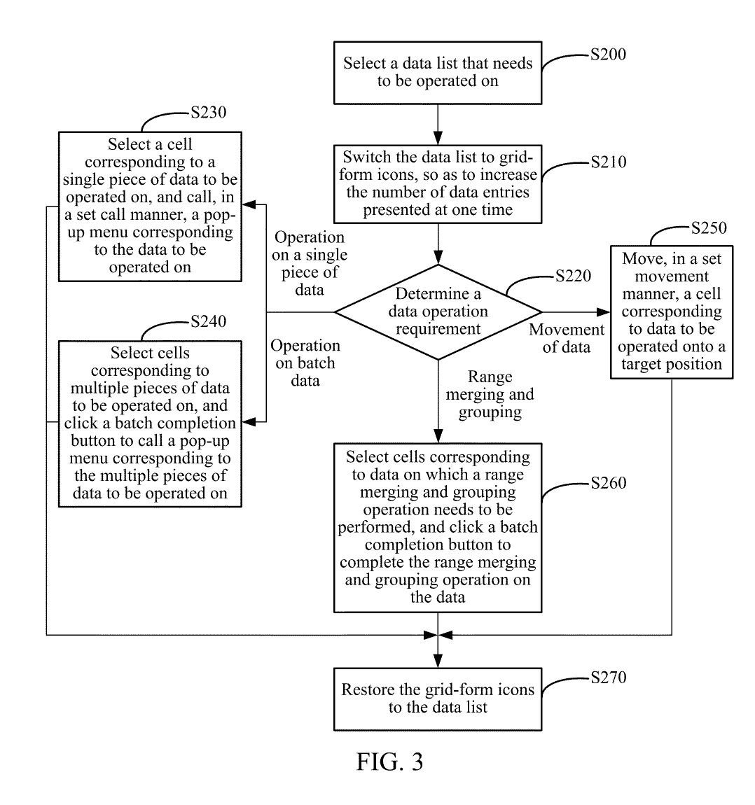

Referring to FIG. 3, FIG. 3 is a flowchart of an interaction method for listing data on a mobile terminal according to a second embodiment of the present disclosure. The interaction method for listing data on a mobile terminal in the second exemplary embodiment of the present disclosure includes the following steps: Step 200 to select a data list that needs to be operated on, and Step 210 to switch the data list to grid-form icons, so as to increase the number of data entries displayable at one time.

In Step 210, a manner of switching the data list may be set according to user preferences. In this embodiment of the present disclosure, the manner of switching the data list is, for example, multi-finger touch and pinch. The number of data entries displayed at one time depends on the size of a cell of the grid-form icons. When a cell is bigger, less data is displayed at one time. When a cell is smaller, more data is displayed at one time. A user may set the size of a cell according to entries in a data list. In this embodiment of the present disclosure, after switching to grid-form icons, the number of displayed data entries increases from

$$\frac{h}{Lh}$$

displayed in an original list format to

$$\frac{h \times w}{{gh}^{2}} ,$$

where h is the height of the list, Lh is the height of a line, w is the width of the list, and gh is the height of a cell. Specifically, referring to FIG. 2, FIG. 2 is a schematic diagram of an operation of switching a data list to grid-form icons in the present disclosure. The present disclosure greatly increases, by using format switching between ListView (which may display items in four different views, and by using this control, items may be formed into a column with or without a column header, and an accompanying icon and text may be displayed) and Gridview (which is a composite control, and presents, in a tabular form, multiple columns of data), the number of data entries displayed at one time, so as to manage more data lists, and perform an operation on a single piece of data or batch data in a visual and convenient manner, thereby preventing inconvenience caused by frequent slides on a screen or/and a long press on a scroll bar.

Step 220 includes determining a data operation requirement of a user, so as to determine which data operation the user needs to perform. If the user needs to perform an operation on a single piece of data, perform Step 230; if the user needs to perform an operation on multiple pieces of data, perform Step 240; if the user needs to move data, perform Step 250; and if the user needs to perform area merging and grouping of data, perform Step 260.

Step 230 includes selecting a cell corresponding to a single piece of data to be operated on, and call, in a set call manner, a pop-up menu corresponding to the data to be operated on.

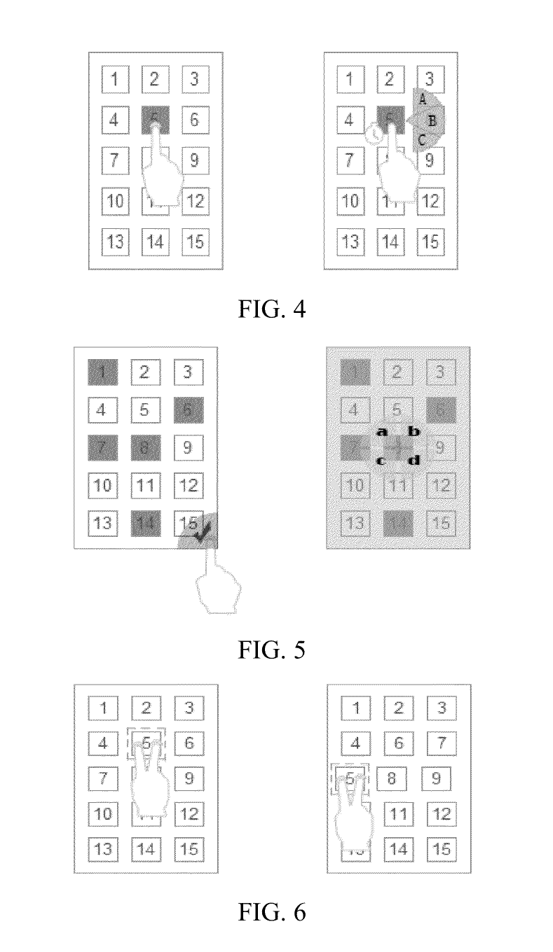

In Step 230, a manner of selecting the cell and a manner of calling the menu may be set according to a user requirement. In this embodiment of the present disclosure, the manner of selecting the cell is clicking on a cell, and the manner of calling the menu is long-pressing the cell. Specifically, referring to FIG. 4, FIG. 4 is a schematic diagram of an operation on a single piece of data on grid-form icons in the present disclosure. The present disclosure performs an operation on data by using a gesture and a pop-up menu, which makes an operation on a single piece of data or batch data more visual and convenient.

Step 240 includes selecting cells corresponding to multiple pieces of data to be operated on, and click on a batch completion button to call a pop-up menu corresponding to the multiple pieces of data to be operated on.

In Step 240, when the user selects more than one cell, the batch completion button appears on a screen of the mobile terminal, and the position of the batch completion button may be set according to different requirements. In this embodiment of the present disclosure, the batch completion button is set on the bottom right on the screen of the mobile terminal. Specifically, referring to FIG. 5, FIG. 5 is a schematic diagram of an operation on batch data on grid-form icons in the present disclosure. However, a person skilled in the art should understand that, the batch completion button may be set at any other position on the screen of the mobile terminal.

Step 250 includes moving, in a set movement manner, a cell corresponding to data to be operated onto a target position.

In Step 250, the manner of moving the cell may be set according to different requirements. In this embodiment of the present disclosure, the manner of moving the cell is, for example, touching a same cell with two fingers to trigger movement. Specifically, referring to FIG. 6, FIG. 6 is a schematic diagram of a data movement operation on grid-form icons in the present disclosure.

Step 260 includes selecting cells corresponding to data on which an area merging and grouping operation needs to be performed, and click on a batch completion button to complete the area merging and grouping operation on the data.

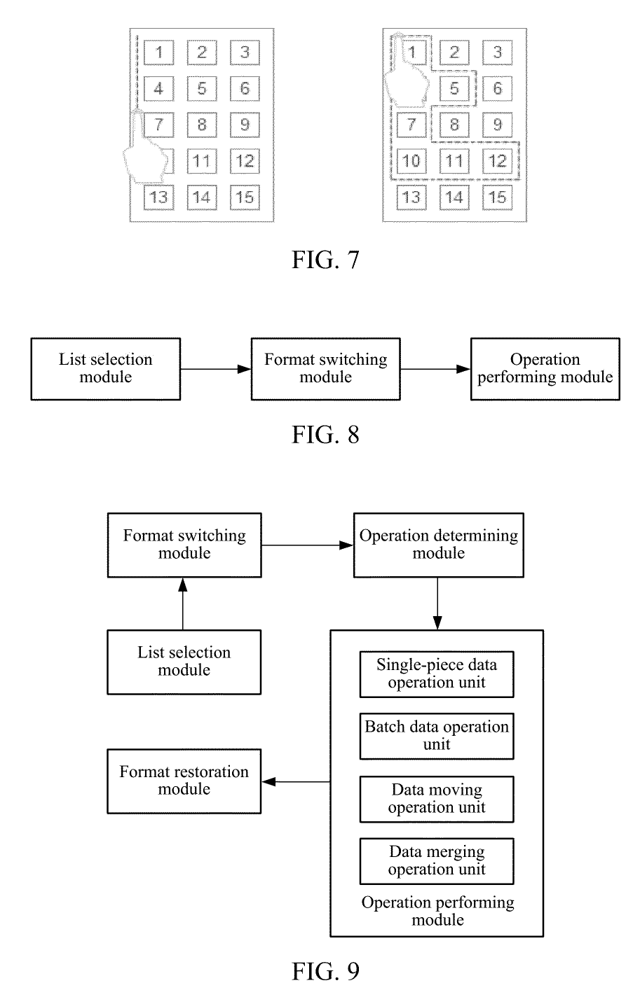

In Step 260, a manner of the area merging and grouping operation may be set according to different requirements. In this embodiment of the present disclosure, the manner of the area merging and grouping operation is, for example, moving a finger in a blank area of the corresponding cells to leave a trajectory. The batch completion button appears on a screen of a mobile terminal when the trajectory is closed, and clicking on the batch completion button to complete the area merging and grouping operation on data of corresponding cells within the trajectory. Specifically, referring to FIG. 7, FIG. 7 is a schematic diagram of an area merging and grouping operation on the data on grid-form icons in the present disclosure.

Step 270 includes restoring the grid-form icons to the data list.

In Step 270, a manner of restoring the data list may be set according to different requirements. In this embodiment of the present disclosure, the manner of restoring the data list is multi-finger touch and release.

Referring to FIG. 8, FIG. 8 is a schematic structural diagram of an interaction apparatus for listing data on a mobile terminal according to a first exemplary embodiment of the present disclosure.

The interaction apparatus for listing data on a mobile terminal in the first embodiment of the present disclosure includes a list selection module, a format switching module, and an operation performing module.

The list selection module is configured to select a data list that needs to be operated on.

The format switching module is configured to switch the data list to grid-form icons, so as to increase the number of data entries displayable at one time. A manner of switching the data list may be set according to user preferences. In this embodiment of the present disclosure, the manner of switching the data list is multi-finger touch and pinch. The number of data entries displayed at one time depends on the size of a cell of the grid-form icons. When a cell is bigger, less data is displayed at one time. When a cell is smaller, more data is displayed at one time. A user may set the size of a cell according to entries in a data list. In this embodiment of the present disclosure, after switching to grid-form icons, the number of displayed data entries increases from

$$\frac{h}{Lh}$$

displayed in an original list format to

$$\frac{h \times w}{{gh}^{2}} ,$$

where h is the height of the list, Lh is the height of a line, w is the width of the list, and gh is the height of a cell.

Specifically, referring to FIG. 2, FIG. 2 is a schematic diagram of an operation of switching a data list to grid-form icons in the present disclosure. The present disclosure greatly increases, by using format switching between ListView (which may display items in four different views, and by using this control, items may be formed into a column with or without a column header, and an accompanying icon and text may be displayed) and Gridview (which is a composite control, and presents, in a tabular form, multiple columns of data), the number of data entries displayed at one time, so as to manage more data lists, and perform an operation on a single piece of data or batch data in a visual and convenient manner, thereby preventing inconvenience caused by frequent slides on a screen or/and a long press on a scroll bar.

The operation performing module is configured to perform a corresponding data operation according to a set operation manner for the grid-form icons.

Referring to FIG. 9, FIG. 9 is a schematic structural diagram of an interaction apparatus for listing data on a mobile terminal according to a second exemplary embodiment of the present disclosure.

The interaction apparatus for listing data on mobile terminal in the second embodiment of the present disclosure includes a list selection module, a format switching module, an operation determining module, an operation performing module, and a format restoration module.

The list selection module is configured to select a data list that needs to be operated on.

The format switching module is configured to switch the data list to grid-form icons, so as to increase the number of data entries displayed at one time. A manner of switching the data list may be set according to user preferences. In this embodiment of the present disclosure, the manner of switching the data list is multi-finger touch and pinch. The number of data entries to be displayed depends on the size of a cell of the grid-form icons. When a cell is bigger, less data is displayed at one time. When a cell is smaller, more data is displayed at one time. A user may set the size of a cell according to entries in a data list. In this embodiment of the present disclosure, after switching to grid-form icons, the number of displayed data entries increases from

$$\frac{h}{Lh}$$

displayed in an original list format to

$$\frac{h \times w}{{gh}^{2}} ,$$

where h is the height of the list, Lh is the height of a line, w is the width of the list, and gh is the height of a cell.

Specifically, referring to FIG. 2, FIG. 2 is a schematic diagram of an operation of switching a data list to grid-form icons in the present disclosure. The present disclosure greatly increases, by using format switching between ListView (which may display items in four different views, and by using this control, items may be formed into a column with or without a column header, and an accompanying icon and text may be displayed) and Gridview (which is a composite control, and presents, in a tabular form, multiple columns of data), the number of data entries displayed at one time, so as to manage more data lists, and perform an operation on a single piece of data or batch data in a visual and convenient manner, thereby preventing inconvenience caused by frequent slides on a screen or/and a long press on a scroll bar.

The operation determining module is configured to determine a data operation requirement of a user, so as to determine which data operation is to be performed, and perform a corresponding data operation according to a set operation manner for the grid-form icons by using the operation performing module. In this embodiment of the present disclosure, the data operation requirement of the user includes operations such as an operation on a single piece of data, an operation on multiple pieces of data, movement of data, and area merging and grouping of data. Although the present disclosure lists several data operation requirements of the user, a person skilled in the art should understand that, the data operation requirements are not limited to the ones listed in the present disclosure, and according to an actual need, another data operation requirement is also included in the scope of the present disclosure.

The operation performing module is configured to perform a corresponding data operation according to a set operation manner for the grid-form icons. Specifically, the operation performing module includes a single-piece data operation unit for operating a single piece of data, a batch data operation unit for operating multiple pieces of data, a data moving operation unit for moving data, and a data merging operation unit for performing area merging and grouping of data.

The single-piece data operation unit is configured to select a cell corresponding to a single piece of data to be operated on, and call, in a set call manner, a pop-up menu corresponding to the data to be operated on. A manner of selecting the cell and a manner of calling the menu may be set according to a user requirement. In this embodiment of the present disclosure, the manner of selecting the cell is clicking on a cell, and the manner of calling the menu is long-pressing the cell. Specifically, referring to FIG. 4, FIG. 4 is a schematic diagram of an operation on a single piece of data on grid-form icons in the present disclosure.

The batch data operation unit is configured to select cells corresponding to multiple pieces of data to be operated on, and click on a batch completion button to call a pop-up menu corresponding to the multiple pieces of data to be operated on. When a user selects more than one cell, the batch completion button appears on a screen of the mobile terminal, and the position of the batch completion button may be set according to different requirements. In this embodiment of the present disclosure, the batch completion button is set on the bottom right on the screen of the mobile terminal. Specifically, referring to FIG. 5, FIG. 5 is a schematic diagram of an operation on batch data on grid-form icons in the present disclosure.

The data moving operation unit is configured to move, in a set movement manner, a cell corresponding to data to be operated onto a target position. The manner of moving the cell may be set according to different requirements. In this embodiment of the present disclosure, the manner of moving the cell is touching a same cell with two fingers to trigger movement. Specifically, referring to FIG. 6, FIG. 6 is a schematic diagram of a data movement operation on grid-form icons in the present disclosure.

The data merging operation unit is configured to select cells corresponding to data on which an area merging and grouping operation needs to be performed, and click on a batch completion button to complete the area merging and grouping operation on the data. A manner of the area merging and grouping operation may be set according to different requirements. In this embodiment of the present disclosure, the manner of the area merging and grouping operation is moving a finger in a blank area of the corresponding cells to leave a trajectory. The batch completion button appears on a screen of a mobile terminal when the trajectory is closed, and clicking on the batch completion button to complete the area merging and grouping operation on data of corresponding cells within the trajectory. Specifically, referring to FIG. 7, FIG. 7 is a schematic diagram of an area merging and grouping operation on the data on grid-form icons in the present disclosure.

The format restoration module is configured to restore the grid-form icons to the data list. A manner of restoring the data list may be set according to different requirements. In this embodiment of the present disclosure, the manner of restoring the data list is multi-finger touch and release.

The technical solutions in the embodiments of the present disclosure have the following beneficial effects. The interaction method and apparatus for listing data on a mobile terminal in the embodiments of the present disclosure greatly increase, by using format switching between ListView and Gridview, the number of data entries displayed at one time, so as to manage more data lists; and perform an operation on data by using a gesture and a pop-up menu, and perform an operation on a single piece of data or batch data in a visual and convenient manner, thereby preventing inconvenience caused by frequent slides on a screen or/and a long press on a scroll bar, and improving operation efficiency. In addition, a data operation gesture in the present disclosure may be set according to different user preferences, so as to meet a personalization requirement of a user.

The embodiments of the present invention may construct the interaction apparatus for listing data on a mobile terminal according to the embodiments of the present invention, and implement the interaction method for listing data on a mobile terminal according to the embodiments of the present invention, by running, on a general-purpose computing device such as a computer that includes processing components and storage components such as a central processing unit (CPU), a random access memory (RAM), and a read-only memory (ROM), a computer program (including program code) that can execute the interaction method for listing data on a mobile terminal according to the embodiments of the present invention. For example, the computer program may be recorded in a computer readable recording medium, and loaded into the foregoing computing device by using the computer readable recording medium, and run in the foregoing computing device.

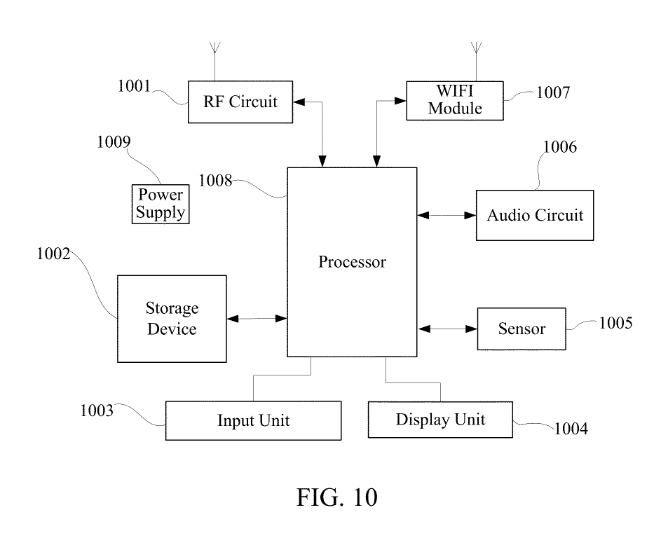

FIG. 10 is a structural diagram of an exemplary mobile terminal 1000 consistent with various disclosed embodiments. The disclosed apparatus can be included in the exemplary mobile terminal 1000.

The exemplary mobile terminal 1000 can include an RF (Radio Frequency) circuit 1001, a storage device 1002 including one or more computer-readable storage media, an input unit 1003, a display unit 1004, a sensor 1005, an audio circuit 1006, a WIFI (Wireless Fidelity) module 1007, a processor 1008 including one or more processing cores, a power supply 1009, and/or other components. In various embodiments, the terminal device(s) described herein can include more or less components as depicted in FIG. 10. Certain components/parts can be omitted, combined, replaced, and/or added.

The RF circuit 1001 can be used to send/receive information or send/receive signal during communication. In particular, after receiving downlink information from a base station, such information can be processed by the one or more processors 1008. Further, the data related to the uplink can be sent to the base station. Generally, the RF circuit 1001 can include, but be not limited to, an antenna, at least one amplifier, a tuner, one or more oscillators, a user identity module (SIM) card, a transceiver, a coupler, a LNA (i.e., Low Noise Amplifier), a duplexer, etc. In addition, the RF circuit 1001 can communicate with other devices via a wireless communication network. The wireless communication can use any communication standards or protocols, including but not limited to, GSM (Global System for Mobile Communications), GPRS (General Packet Radio Service), CDMA (Code Division Multiple Access), WCDMA (Wideband Code Division Multiple Access), LTE (Long Term Evolution), e-mail, and SMS (Short Messaging Service).

The storage device 1002 can be used for storing software programs and modules, such as those software programs and modules corresponding to the disclosed methods for listing data. By running software programs and modules stored in the storage device 1002, the processor 1008 can perform various functional applications and the disclosed methods. The storage device 1002 can include a program storage area and a data storage area. The program storage area can store the operating system, applications (such as sound playback, image playback, etc.) required by at least one function. The data storage area can store data (such as audio data, phone book, etc.) created when using the mobile terminal 1000. In addition, the storage device 1002 can include a high-speed random access memory and a non-volatile memory. For example, the storage device 1002 can include at least one disk memory, flash memory, and/or other volatile solid-state memory elements. Accordingly, the storage device 1002 can further include a memory controller to provide the processor 1008 and the input unit 1003 with access to the storage device 1002.

The input unit 1003 can be used to receive inputted numeric or character information, and to generate signal input of keyboard, mouse, joystick, and trackball or optical signal input related to the user settings and function controls. Specifically, the input unit 1003 can include a touch sensitive surface and other input device(s). The touch-sensitive surface, also known as a touch screen or touch panel, can collect touch operations that a user conducts on or near the touch-sensitive surface. For example, a user can use a finger, a stylus, and any other suitable object or attachment on the touch-sensitive surface or on an area near the touch-sensitive surface. The touch-sensitive surface can drive a connecting device based on a preset program. Optionally, the touch sensitive surface can include a touch detection device and a touch controller. The touch detection device can detect user's touch position and detect a signal due to a touch operation and then send the signal to the touch controller. The touch controller can receive touch information from the touch detection device, convert the touch information into contact coordinates to send to the processor 1008, and receive commands sent from the processor 1008 to execute. Furthermore, the touch sensitive surface can be realized by resistive, capacitive, infrared surface acoustic wave, and/or other types of surface touch. In addition to the touch sensitive surface, the input unit 1003 can also include other input device(s). Specifically, the other input device(s) can include, but be not limited to, a physical keyboard, function keys (such as volume control buttons, switch buttons, etc.), a trackball, a mouse, an operating lever, or combinations thereof.

The display unit 1004 can be used to display information inputted by the user, information provided to the user, and a variety of graphical user interfaces of the mobile terminal 1000. These graphical user interfaces can be formed by images, text, icons, videos, and/or any combinations thereof. The display unit 1004 can include a display panel configured by, e.g., LCD (Liquid Crystal Display), OLED (Organic Light-Emitting Diode), etc. Further, the touch sensitive surface can cover the display panel 101. When the touch sensitive surface detects a touch operation on or near the touch sensitive surface, the touch operation can be sent to the processor 1008 to determine a type of the touch operation. Accordingly, the processor 1008 can provide visual output on the display panel 101. Although in FIG. 10 the touch-sensitive surface and the display panel are shown as two separate components to achieve input and output functions, in some embodiments, the touch sensitive surface and the display panel can be integrated to perform input and output functions.

The mobile terminal 1000 can further include at least one sensor 1005, such as optical sensors, motion sensors, and other suitable sensors. Specifically, the optical sensors can include an ambient optical sensor and a proximity sensor. The ambient optical sensor can adjust brightness of the display panel according to the brightness of ambient light. The proximity sensor can turn off the display panel and/or turn on backlighting, when the mobile terminal 1000 moves to an ear. As a type of motion sensor, a gravity sensor can detect amount of an acceleration in each direction (e.g., including three axis) and detect magnitude and direction of gravity when in stationary. The gravity sensor can be used to identify phone posture (for example, switching between horizontal and vertical screens, related games, magnetometer calibration posture, etc.), and/or vibration recognition related functions (e.g., pedometer, percussion, etc.). The mobile terminal 1000 can also be configured with, e.g., a gyroscope, a barometer, a hygrometer, a thermometer, an infrared sensor, and/or other sensors.

The audio circuit 1006, the speaker, and the microphone can provide an audio interface between the user and mobile terminal 1000. The audio circuit 1006 can transmit an electrical signal converted from the received audio data to the speaker to convert into audio signal output. On the other hand, the microphone can convert the collected sound signal to an electrical signal, which can be received by the audio circuit 1006 to convert into audio data. The audio data can be output to the processor 1008 for processing and then use the RF circuit 1001 to transmit to, e.g., another terminal device. Alternatively, the audio data can be output to the storage device 1002 for further processing. The audio circuit 1006 can also include an earplug jack to provide communications between the peripheral headset and the mobile terminal 1000.

WiFi is used as a short-range wireless transmission technology. The mobile terminal 1000 can use the WIFI module 1007 to help users send/receive emails, browse websites, access streaming media, etc. The WIFI module 1007 can provide users with a wireless or wired broadband Internet access. In various embodiments, the transport module 1007 can be configured within or outside of the mobile terminal 1000 as depicted in FIG. 10.

The processor 1008 can be a control center of the mobile terminal 1000: using a variety of interfaces and circuits to connect various parts, e.g., within a mobile phone; running or executing software programs and/or modules stored in the storage device 1002; calling the stored data in the storage device 1002; and/or performing various functions and data processing of the mobile terminal 1000, e.g., to monitor the overall mobile phone. Optionally, the processor 1008 can include one or more processing cores. In an exemplary embodiment, the processor 1008 can integrate application processor with modulation and demodulation processor. The application processor is mainly used to process operating system, user interface, and applications. The modulation and demodulation processor is mainly used to deal with wireless communications. In various embodiments, the modulation and demodulation processor may or may not be integrated into the processor 1008.

The mobile terminal 1000 can further include a power supply 1009 (e.g., a battery) to power various components of the terminal device. In an exemplary embodiment, the power supply can be connected to the processor 1008 via the power management system, and thus use the power management system to manage charging, discharging, and/or power management functions. The power supply 1009 can also include one or more DC or AC power supplies, a recharging system, a power failure detection circuit, a power converter or inverter, a power status indicator, and/or any other suitable components.

Although not shown in FIG. 10, the mobile terminal 1000 can further include a camera, a Bluetooth module, etc., without limitations.

The processor(s) 1008 of the mobile terminal 1000 can upload executable files corresponding to processes of one or more programs to the storage device 1002. The processor(s) 1008 can then be used to run these one or more programs stored in the storage device 1002. For example, the processor(s) 1008 can at least be configured to perform the disclosed methods for listing data as disclosed in FIGS. 1-7.

The above are only preferred embodiments of the present disclosure, and are not intended to limit the present disclosure in any form. Although the present disclosure has been disclosed above through the preferred embodiments, the embodiments are not intended to limit the present disclosure. A person skilled in the art can make some variations or modifications to the above-disclosed technical content without departing from the scope of the technical solutions of the present disclosure to obtain equivalent embodiments with equivalent changes. Any simple modification, equivalent change or modification made to the above embodiments according to the technical essence of the present disclosure without departing from the content of the technical solutions of the present disclosure shall fall within the scope of the technical solutions of the present disclosure.

What is claimed is:

1. An interaction method for listing data on a mobile terminal, comprising:
selecting a data list that needs to be operated on;
switching the data list to grid-form icons, so as to increase the number of displayable data entries; and
performing a corresponding data operation according to a set operation manner for the grid-form icons.

2. The interaction method for listing data on the mobile terminal according to claim 1, wherein the step of switching the data list to the grid-form icons, so as to increase the number of displayable data entries includes a manner of switching the data list to the grid-form icons comprises: multi-finger touch and pinch, wherein the number of the displayable data entries increases from
$$\frac{h}{Lh}$$
displayed in an original list format to
$$\frac{h \times w}{{gh}^{2}} ,$$
wherein h is a height of the data list, Lh is a height of a line, w is a width of the data list, and gh is a height of a cell of the data list.

3. The interaction method for listing data on the mobile terminal according to claim 1, wherein, in the step of performing the corresponding data operation according to the set operation manner for the grid-form icons, the data operation comprises an operation on a single piece of data, an operation on multiple pieces of data, movement of data, and area merging and grouping of data.

4. The interaction method for listing data on the mobile terminal according to claim 3, wherein the step of performing the corresponding data operation according to the set operation manner for the grid-form icons further comprises:
determining a data operation requirement of a user, so as to determine whether the user needs to perform an operation on a single piece of data, an operation on multiple pieces of data, movement of data, or area merging and grouping of data.

5. The interaction method for listing data on the mobile terminal according to claim 4, comprising:
if it is determined that the user needs to perform the operation on the single piece of data, selecting a cell corresponding to a single piece of data to be operated on, and calling, in a set call manner, a pop-up menu corresponding to the data to be operated on,
wherein a manner of selecting the cell comprises clicking on the cell, and the set call manner of calling the pop-up menu comprises long-pressing the cell.

6. The interaction method for listing data on the mobile terminal according to claim 4, comprising:
if it is determined that the user needs to perform the operation on multiple pieces of data, selecting cells corresponding to the multiple pieces of data to be operated on, and clicking on a batch completion button to call a pop-up menu corresponding to the multiple pieces of data to be operated on,
wherein the batch completion button is set in any corner of a screen of the mobile terminal.

7. The interaction method for listing data on the mobile terminal according to claim 4, comprising:
if it is determined that the user needs to move data, moving, in a set movement manner, a cell corresponding to data to be operated onto a target position,
wherein the set movement manner of moving the cell comprises touching a same cell with two fingers to trigger a movement.

8. The interaction method for listing data on the mobile terminal according to claim 4, comprising:
if it is determined that the user needs to perform the area merging and grouping of data, selecting cells corresponding to the data on which a area merging and grouping operation needs to be performed, and clicking on a batch completion button to complete the area merging and grouping operation on the data,
wherein a manner of the area merging and grouping operation comprises: moving a finger in a blank area of the corresponding cells to leave a trajectory,
wherein the batch completion button appears on a screen of the mobile terminal when the trajectory is closed, and clicking on the batch completion button to complete the area merging and grouping operation on data of corresponding cells within the trajectory.

9. The interaction method for listing data on the mobile terminal according to claim 1, after the step of performing the corresponding data operation according to the set operation manner for the grid-form icons, further comprising:
restoring the grid-form icons to the data list, wherein a manner of restoring the data list is multi-finger touch and release.

10. The interaction method for listing data on the mobile terminal according to claim 3, after the step of performing the corresponding data operation according to the set operation manner for the grid-form icons, further comprising:
restoring the grid-form icons to the data list, wherein a manner of restoring the data list is multi-finger touch and release.

11. The interaction method for listing data on the mobile terminal according to claim 4, after the step of performing the corresponding data operation according to the set operation manner for the grid-form icons, further comprising:
restoring the grid-form icons to the data list, wherein a manner of restoring the data list is multi-finger touch and release.

12. An interaction apparatus for listing data on the mobile terminal, comprising:
a list selection module, configured to select a data list that needs to be operated on;
a format switching module, configured to switch the data list to grid-form icons, so as to increase the number of displayable data entries; and
an operation performing module, configured to perform a corresponding data operation according to a set operation manner for the grid-form icons.

13. The interaction apparatus for listing data on the mobile terminal according to claim 12, wherein a manner of switching the data list by the format switching module is multi-finger touch and pinch, wherein the number of the displayable data entries increases from
$$\frac{h}{Lh}$$
displayed in an original list format to
$$\frac{h \times w}{{gh}^{2}} ,$$
wherein h is a height of the data list, Lh is a height of a line, w is a width of the data list, and gh is a height of a cell of the data list.

14. The interaction apparatus for listing data on the mobile terminal according to claim 12, further comprising an operation determining module,
wherein the operation determining module is configured to determine a data operation requirement of a user, so as to determine to perform one of the following data operations by using the operation performing module: an operation on a single piece of data, an operation on multiple pieces of data, movement of data, or area merging and grouping of data.

15. The interaction apparatus for listing data on the mobile terminal according to claim 14, wherein the operation performing module further comprises a single-piece data operation unit for operating the single piece of data, configured to select a cell corresponding to a single piece of data to be operated on, and call, in a set call manner, a pop-up menu corresponding to the data to be operated on, and wherein a manner of selecting the cell is clicking on the cell, and the set call manner of calling the pop-up menu is long-pressing the cell.

16. The interaction apparatus for listing data on the mobile terminal according to claim 14, wherein the operation performing module further comprises a batch data operation unit for operating the multiple pieces of data, configured to select cells corresponding to multiple pieces of data to be operated on, and click on a batch completion button to call a pop-up menu corresponding to the multiple pieces of data to be operated on, wherein the batch completion button is set in any corner of a screen of the mobile terminal.

17. The interaction apparatus for listing data on the mobile terminal according to claim 14, wherein the operation performing module further comprises a data moving operation unit for moving the data, configured to move, in a set movement manner, a cell corresponding to data to be operated onto a target position, wherein the set movement manner of moving the cell is touching a same cell with two fingers to trigger a movement.

18. The interaction apparatus for listing data on the mobile terminal according to claim 14, wherein the operation performing module further comprises a data merging operation unit for performing the area merging and grouping of data, configured to select cells corresponding to data on which an area merging and grouping operation needs to be performed, and click on a batch completion button to complete the area merging and grouping operation on the data,
wherein a manner of the area merging and grouping operation is: moving a finger in a blank area of the corresponding cells to leave a trajectory, wherein the batch completion button appears on a screen of the mobile terminal when the trajectory is closed, and clicking on the batch completion button to complete the area merging and grouping operation on data of corresponding cells within the trajectory.

19. The interaction apparatus for listing data on the mobile terminal according to claim 12, wherein the apparatus further comprises a format restoration module, configured to restore the grid-form icons to the data list, wherein a manner of restoring the data list is multi-finger touch and release.

20. The interaction apparatus for listing data on the mobile terminal according to claim 14, wherein the apparatus further comprises a format restoration module, configured to restore the grid-form icons to the data list, wherein a manner of restoring the data list is multi-finger touch and release.
